(19) United States
(12) Patent Application Publication
(10) Pub. No.: US 2026/0059491 A1
(43) Pub. Date: Feb. 26, 2026

(54) APPARATUS AND METHODS FOR MACHINE LEARNING MODEL TRAINING IN MULTI-BEAM COMMUNICATION SYSTEMS

(71) Applicant: QUALCOMM Incorporated, San Diego, CA (US)

(72) Inventors: Mukesh KUMAR, Hyderabad (IN); Srinivas YERRAMALLI, San Diego, CA (US); Alexandros MANOLAKOS, Athens (GR)

(21) Appl. No.: 19/114,404

(22) PCT Filed: Oct. 11, 2023
(86) PCT No.: PCT/US2023/076530

§ 371 Date: Mar. 21, 2025

(30) Foreign Application Priority Data
Nov. 18, 2022 (GR) 20220100954

(51) Int. Cl. H04W 64/00; G06N 20/00; H04B 17/391; H04W 24/10

(52) U.S. Cl. CPC H04W 64/006; G06N 20/00; H04B 17/3913; H04W 24/10

(57) ABSTRACT

Methods, systems, and apparatuses for training machine learning processes in multi-beam wireless communication systems. For example, a computing device generates a measurement request message for one or more statistical values that are determined based on beam measurements taken over a measurement interval. The computing device transmits the measurement request message to a user equipment, where the measurement request message causes the user equipment to determine the one or more statistical values based one or more beam measurements determined over one or more of the measurement intervals. Further, the computing device receives, from the user equipment, a measurement response message that includes the one or more statistical values. The computing device also trains a machine learning model based on the one or more statistical values.

### BACKGROUND

### Field of the Disclosure

This disclosure relates generally to wireless communication systems and, more specifically, to training machine learning models in multi-beam wireless communication systems.

### Description of Related Art

Wireless communication systems can provide various telecommunications services including, for example, audio, video, data, messaging, and network access, among other others. For instance, wireless communication systems may allow for communications among various devices, such as Internet of Things (IoT) devices. These wireless communication systems can be based on various technologies, such as code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TDSCDMA) systems, Long Term Evolution (LTE) systems, WiMax systems, and Evolved High Speed Packet Access (HSPA+) systems. These and other wireless communication systems may conform to a standard, such as the third generation (3G) of broadband cellular network technology, the fourth generation (4G) of broadband cellular network technology, and more recently the fifth generation (5G) of broadband cellular network technology (also known as New Radio (NR)). A wireless communication system may include a number of base stations (BSs) that allow communication for a number of user equipment (UE). For example, a UE may receive data from a BS in a downlink, and may transmit data to a BS in an uplink.

The wireless communication system may also provide location services, such as the detection of a UE's location. For instance, in a 5G network, a UE may detect a beam of a BS, and may perform measurement operations on the beam, such as determining the signal strength of the beam, to generate measurement information. In some instances, the UE applies a trained machine learning model to the measurement information to determine the UE's position, and transmits the determined position to the BS or other network entity, such as a location management function (LMF). In other instances, the UE transmits the measurement information to the BS, and the BS applies the trained machine learning model to the measurement information to determine the UE's position. To train the machine learning model, an LMF may aggregate measurement information received from a plurality of UEs, and may train a machine learning model with the aggregated measurement information. In some instances, the LMF transmits the trained machine learning model to UEs for use in determining their position.

### SUMMARY

According to one aspect, a method includes generating a measurement request message for one or more reporting values that are determined based on at least one reporting condition of one or more beam measurements. The method also includes transmitting the measurement request message to a user equipment, the measurement request message causing the user equipment to determine the one or more reporting values based on the at least one reporting condition of the one or more beam measurements. Further, the method includes receiving, from the user equipment, a measurement response message comprising the one or more reporting values. The method also includes training a machine learning model based on the one or more reporting values.

According to another aspect, an apparatus comprises a non-transitory, machine-readable storage medium storing instructions, and at least one processor coupled to the non-transitory, machine-readable storage medium. The at least one processor is configured to generate a measurement request message for one or more reporting values that are determined based on at least one reporting condition of one or more beam measurements. The at least one processor is also configured to transmit the measurement request message to a user equipment, the measurement request message causing the user equipment to determine the one or more reporting values based on the at least one reporting condition of the one or more beam measurements. Further, the at least one processor is configured to receive, from the user equipment, a measurement response message comprising the one or more reporting values. The at least one processor is also configured to train a machine learning model based on the one or more reporting values.

According to another aspect, a non-transitory, machine-readable storage medium stores instructions that, when executed by at least one processor, causes the at least one processor to perform operations that include generating a measurement request message for one or more reporting values that are determined based on at least one reporting condition of one or more beam measurements. The operations also include transmitting the measurement request message to a user equipment, the measurement request message causing the user equipment to determine the one or more reporting values based on the at least one reporting condition of the one or more beam measurements. Further, the operations include receiving, from the user equipment, a measurement response message comprising the one or more reporting values. The operations also include training a machine learning model based on the one or more reporting values.

According to another aspect, an apparatus includes a means for generating a measurement request message for statistical data of one or more beam measurements. The apparatus also includes a means for transmitting the measurement request message to a user equipment, the measurement request message causing the user equipment to determine one or more statistical values based on the one or more beam measurements. Further, the apparatus includes a means for receiving a measurement response message from the user equipment, wherein the measurement response message comprises the one or more statistical values. The apparatus also includes a means for training a machine learning model based on the one or more statistical values.

### BRIEF DESCRIPTION OF DRAWINGS

FIG. 1 is a block diagram of an exemplary wireless communication system, according to some implementations;

FIG. 2 is a block diagram of an exemplary network device, according to some implementations;

FIGS. 3, 4A, and 4B illustrate communications among networked devices, according to some implementations;

FIG. 5 is a flowchart of an exemplary process for communicating measurement data, according to some implementations;

FIG. 6 is a flowchart of an exemplary process for training a machine learning model, according to some implementations; and

FIG. 7 is a flowchart of another exemplary process for training a machine learning model, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

Base stations (BSs), which may also be referred to as a Node B, a gNB, a transmit receive point (TRP), an access point (AP), and the like, when operating in a wireless communication system such as New Radio (NR), may transmit positioning reference signals (PRSs) within one or more beams that user equipments (UEs) can detect. In some instances, a UE may receive assistance data, such as from a location management function (LMF), that identifies downlink PRS resources (e.g., DL-PRS resources) transmitted from a BS that the UE can detect. For instance, DL-PRS may include up to four frequency layers, where each frequency layer may identify up to sixty-four TRPs. Further, for each TRP, DL-PRS may identify two PRS resource sets, where each PRS resource set may include up to sixty-four PRS resources. In some examples, an LMF may generate the assistance data such that the up to four frequency layers are in order of priority (e.g., a decreasing order of measurement priority, such as where the first frequency layer in the assistance data has highest priority, and the last frequency layer in the assistance data has least priority), the up to sixty-four TRPs for each frequency layer are in order of priority, the two PRS resource sets for each TRP are in order of priority, and the sixty-four resources of each PRS resource set are in order of priority.

A base station may configure a DL-PRS resource to a number of slots. The allocation of the DL-PRS resource to the number of slots may include, for instance, a periodicity of the DL-PRS resource (e.g., how many slots from a first slot of the DL-PRS resource to a second slot of the same DL-PRS resource), and a slot offset (e.g., how many slots until the first slot for the DL-PRS resource). The allocation may also include one or more of a resource repetition value (e.g., a number of repeated slots for the DL-PRS resource) and a time gap value (e.g., a maximum number of slots between two consecutive resource slots of a same DL-PRS resource). The base station may transmit DL-PRS configurations to, for example, an LMF, and the LMF to report the DL-PRS to UEs within the assistance data.

To determine a UE's position (e.g., geographical location), NR can support one or more UE-assisted or UE-based positioning processes, such as multi-cell round trip time (multi-RTT) positioning, downlink time difference of arrival (DL-TDOA) positioning, and downlink angle of departure (DL-AoD) positioning methods. For UE-assisted positioning processes, conventionally a UE may perform operations to measure DL-PRSs, and may transmit all of the measurements to an LMF. The LMF may then perform operations to compute the UE's position based on the measurements received. For example, the LMF may apply a machine learning process to the received measurements to determine the UE's position. These conventional UE-assisted positioning processes, however, require the transmission of all measurements, thereby increasing network traffic and the use of computation resources (e.g., processing power and time, memory storage, etc.). In addition, because the measurements captured by the UE must be transmitted to the LMF, there may be security concerns (e.g., privacy laws) regarding the LMF storing UE measurement information. For UE-based positioning process, conventionally the UE also performs operations to measure DL-PRSs, and performs further operations to determine its position. The UE may then report the computed position to the LMF. These conventional UE-based positioning processes, however, require the UE to utilize processing resources to determine the UE's location. Moreover, the LMF is restricted from determining the UE's position from measurement information, as the UE does not send that information to the LMF.

To address drawbacks with conventional UE-assisted positioning and UE-based positioning processes, such as one or more of the ones described above, in some implementations, an LMF may request from a UE that the UE generate reporting data based on at least one reporting condition. In some examples, such as in a UE-assisted positioning mode, the reporting condition may include a request for statistical data based on beam measurements, such as PRS measurements. For instance, the LMF may generate and transmit to a UE a measurement request message, the measurement request message causing the UE to determine a statistical value based on DL-PRS measurements captured over a measurement interval (e.g., 4 to 10,240 mill-secs). In some examples, the measurement interval corresponds to a portion of, or a function of, a PRS resource period. The statistical value may be, for example, an average signal strength value over the measurement interval (e.g., an average signal-to-noise ratio (SNR), reference signal received power (RSRP), reference signal received quality (RSRQ), received signal strength indicator (RSSI), etc.). In some examples, the statistical value may be based on UE receive-transmit (Rx-Tx) measurements, time difference of arrival (TDOA) measurements, potential line-of-sight (LOS), near line-of-sight (nLOS), or non-line-of-sight (NLOS) indications, or any other suitable measurements, such as any reporting measurements defined within the 3GPP TS 37.355 specification or any other suitable networking specification.

The UE may receive the measurement request message, and may measure the DL-PRS resources (e.g., periodically) during each measurement interval (e.g., time interval). Further, the UE may determine the statistical value based on the measurements captured during each corresponding measurement interval, and may transmit to the LMF a measurement response message that includes the statistical value. As such, because the UE is transmits statistical values based on measurements taken over a measurement interval, as opposed to all measurements, the amount of data transmitted is reduced over conventional processes.

In some examples, the LMF trains an artificial intelligence process, such as a machine learning process, based on the received statistical values. The machine learning process may be trained to generate output data characterizing a position of a UE-based on features generated from statistical values. For instance, the LMF may generate features based on the received statistical values, and may input the features to the machine learning process during training. Once trained, the machine learning process can generate output data characterizing a UE's position based on features generated from statistical values reported by the UE. For example, a UE may transmit to the LMF statistical values generated from measuring PRS resources transmitted within a beam. The LMF may generate features based on the received statistical values, and may apply the trained machine learning process to the features to generate output data characterizing the UE's position.

In some examples, such as in a UE-based positioning mode, the reporting condition can include a request to transmit position measurements when at least one triggering condition is satisfied. For instance, the LMF may generate and transmit to a UE a measurement request message that identifies one or more triggering conditions and, when received by the UE, causes the UE to report position measurements (e.g., position data identifying the UE's geographical position) when one or more of the triggering conditions are satisfied. In some examples, the measurement request message identifies one or more triggering conditions. The triggering condition can include, for example, a condition that a positioning accuracy value satisfies a positioning accuracy threshold. The positioning accuracy value may include, for instance, one or more of a horizontal error, a vertical error, a total error, a horizontal dilution of precision, a vertical dilution of precision, a position dilution of precision, a time dilution of precision, and a geometric dilution of precision.

For example, the UE, may receive the measurement request message, and based on receiving the measurement request message, may measure PRS resources to determine the UE's position. For instance, the UE may generate features based on PRS measurements captured from one or more beams, and may apply a trained machine learning process to the features to generate position data characterizing one or more positions of the UE. The UE may also determine a positioning accuracy value based on the position data, and may determine whether the positioning accuracy value satisfies the positioning accuracy threshold. If, for example, the determined positioning accuracy value is beyond the positioning accuracy threshold, the UE may transmit to the LMF a measurement response message that includes at least portions of the position data.

As another example, the triggering condition can include a condition that a beam signal-to-noise value (e.g., SNR, RSRP, RSRQ, RSRI, etc.) satisfies a beam signal-to-noise threshold. The UE, may receive the measurement request message, and may measure PRS resources to determine the beam signal-to-noise value. Further, the UE may determine whether the beam signal-to-noise value satisfies the beam signal-to-noise threshold. For example, if a determined signal-to-noise value is beyond the signal-to-noise threshold (e.g., a signal-to-noise value above the signal-to-noise threshold), the UE may generate the position data, and may transmit to the LMF a measurement response message that includes at least portions of the position data.

In some examples, the triggering condition must be satisfied for at least a number of resources, such as a minimum number of resources within a resource set. For example, the measurement request message may identify a minimum number of resources, where the UE determines that a triggering condition is satisfied when a signal-to-noise value for each of at least the minimum number of resources (e.g., 16, etc.) is beyond the signal-to-noise threshold.

In some examples, the measurement request message can include a condition that PRS measurements be stored until requested from the LMF. The LMF may request the PRS measurements after receiving positioning data, for example. For example, the measurement request message may include a reporting interval identifying an amount of time PRS measurements are to be stored after the position data is transmitted. For instance, the measurement request message may identify a number of seconds that PRS measurements are to be stored after position data is transmitted. The LMF, after receiving position data from the UE, is to request the PRS measurements within the number of seconds identified. In some examples, the LMF transmits, to the UE, a second measurement request message within the reporting interval after receiving position data from the UE. In response to receiving the second measurement request, the UE transmits any beam measurements captured since the positioning data was transmitted and up until the second measurement request message was received. In some examples, the LMF does not send a second measurement request message within the reporting interval. In such cases, the UE may discard (e.g., overwrite) the stored beam measurement.

In some examples, an LMF provides an untrained machine learning model to a UE for training. For instance, a machine learning model may be characterized by parameters (e.g., hyperparameters, configuration settings, coefficients, weights, etc.). The LMF may generate a model training request message that includes the machine learning model parameters, and may transmit the model training request message to a UE. The model training request message may cause the UE to establish (e.g., configure and execute) the machine learning model based on the received parameters, and to train the established machine learning model based on PRS measurements. For instance, the UE may train the machine learning model during a number of UE positioning sessions. In some examples, the model training request message includes the number of UE positioning sessions during which the UE is to train the machine learning model. After the UE has trained the machine learning model with PRS measurements generated during the number of positioning sessions, the UE may transmit, to the LMF, the trained machine learning model. For example, the UE may transmit parameters characterizing the trained machine learning model to the LMF.

In some instances, the UE trains the machine learning model periodically (e.g., during every number of positioning sessions), and transmits the trained machine learning model to the LMF after each training session. In some instances, the LMF transmits the trained machine learning model to other UEs to be used during inference. For example, the other UEs may establish the trained machine learning model, and may determine position data based on applying the trained machine learning model to features generated from PRS measurements. As such, while a first UE trains the machine learning model, the LMF facilitates distribution of the trained machine learning model to other UEs to be used to determine their own positions. In some instances, the LMF transmits the trained machine learning model to UEs in a same geographical area as the UE that trained the machine learning model.

In other examples, a UE that possesses the trained machine learning model (e.g., the UE that initially trains the machine learning model) transmits the trained machine learning model to nearby UEs. For instance, the LMF may communicate to an original UE that the original UE can share the trained machine learning model with other UEs that are within a particular geographical area, such as within a particular zone, or within a radius of the original UE. As such, the original UE may transmit the trained machine learning model to any other UE that comes within the particular geographical area. In some examples, only the original UE trains the machine learning model. In other words, the UEs received the trained machine learning model do not further train the model, and instead only apply it during inference (e.g., to determine position data based on beam measurements).

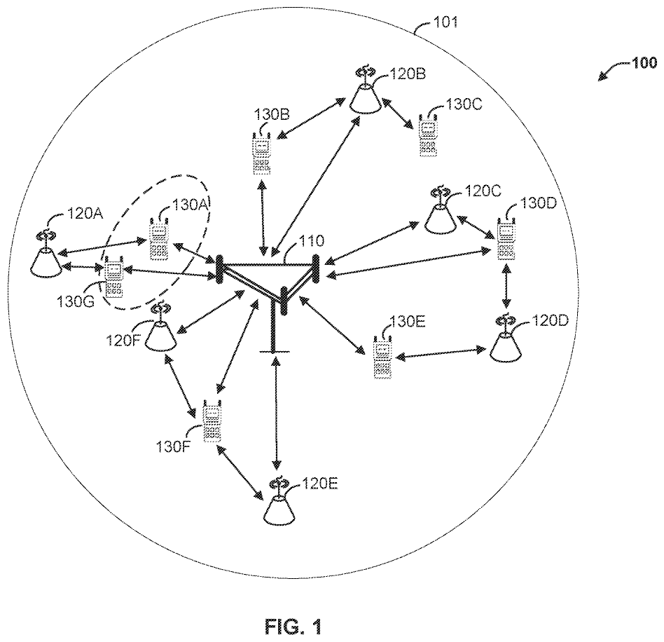

FIG. 1 is a block diagram of at least portions of an exemplary wireless communication system 100, such as a 5G wireless communication system. Wireless communication system 100 includes at least one BS 110 (e.g., a TRP, a gNB), a plurality of UEs 130, and a plurality of LMFs 120. Although wireless communication system 100 may include additional components, such as access and mobility management functions (AMFs), session management functions (SMF), relay stations, and any other suitable components, they are not illustrated for simplicity purposes.

Each UE may be, for example, a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), an Internet telephone, a digital camera, a digital video recorder, a handheld device, such as a portable video game device or a personal digital assistant (PDA), a drone device, a virtual reality device (e.g., a virtual reality headset), an augmented reality device (e.g., augmented reality glasses), or any other suitable device. BS 110 may provide communication coverage for a particular geographical area, such as geographical area 101. For example, geographical area 101 may correspond to a macro cell, a pico cell, a femto cell, or any other type of cell. To provide coverage, BS 110 may transmit one or more beams that cover at least portions of geographical area 101, where each beam operates within a frequency spectrum. For example, BS 110 may transmit data, such as DL-PRS resources, to UEs 130 using beam downlinks. BS 110 may also communicate with LMFs 120. For example, LMFs 120 may request and receive information, such as DL-PRS configurations, from each BS 110.

LMFs 120 may also communicate with UEs 130. For example, LMFs 120 can receive measurement information from any connected UEs 130. Based on the operating mode (e.g., either UE-based or UE-assisted positioning modes), the measurement information may include, for example, one or more of location information (e.g., latitude, longitude, and altitude data), velocity data, reference time data, code phase and Doppler measurements, and beam measurements, among others. Further, LMFs 120 can provide support location services to connected UEs 130. For example, as illustrated, UE 130a and UE 130g are in communication with LMF 120a, and thus LMF 120A can provide location services to UE 130a and UE 130g. Similarly, UEs 130b and 130c are in communication with LMF 120b, and thus LMF 120b can provide location services to UEs 130b, 130c. UE 130d is in communication with each of LMF 120c and LMF 120d, and can receive location services from LMFs 120c, 120d. UE 130e is in communication with, and can receive location services from, LMF 120d. Similarly, UE 130f is in communication with each of LMF 120e and LMF 120f, and thus can receive location services from LMFs 120e, 120f.

For example, and as described herein, LMF 120 may generate a measurement request message for one or more reporting values, and may transmit the measurement request message to a UE 130, such as UE 130a. The measurement request message may cause the UE 130 to determine the reporting values based on at least one reporting condition of one or more beam measurements, such as measurements of a beam of BS 110. As described herein, the reporting condition may include a statistical measurement of beam measurements, such as when in operating in UE-assisted modes. For instance, the measurement request message may cause the UE 130 to determine statistical values based on DL-PRS measurements captured over a measurement interval, and to transmit the one or more statistical values to the LMF 120.

In some instances, the LMF 120 trains a machine learning model based on the received statistical values, as described herein. For example, the LMF 120 may generate features based on received statistical values, and may input the generated features to a machine learning models during training. The LMF 120 may continue to train the machine learning model until one or more metrics (e.g., F1 score, AUC, ROC, log loss, root mean squared error, etc.) are satisfied. For instance, LMF 120 may train the machine learning model until one or more of the metrics meet or exceed a corresponding threshold.

In some instances, such as when operating in UE-based positioning modes, LMF 120 transmits the trained machine learning model to UEs 130, such as UEs 130b, 130C. For instance, LMF 120 may determine that a UE 130 is in a particular geographical area, such as in a same geographical area of another UE 130 that transmitted statistical values used for training the machine learning model, and transmits the trained machine learning model to the UE 130.

In some instances, such as when operating in UE-based positioning modes, the reporting condition may include a triggering condition whereby the UE 130 transmits positioning data when the triggering condition is satisfied. For instance, the measurement request message may cause the UE 130 to transmit position data characterizing the UE's 130 position when a metric, such as a signal strength metric, is above a corresponding threshold. To determine the position data, UE 130 may apply a trained machine learning model to features generated from beam measurements, such as beam measurements for a beam of BS 110. In some examples, the measurement request message identifies one or more of the metric, and the threshold. When the UE 130 detects that the metric exceeds the corresponding threshold, the UE 130 transmits the position data to the LMF 120.

In some instances, the measurement request message indicates to the UE 130 that the LMF 120 will request measurements (e.g., DL-PRS measurements) after receiving position data from UE 130. As such, UE 130 must store beam measurements for a measurement interval, such that the UE 130 may transmit to the LMF 120 the beam measurements once requested. As described herein, in some examples the measurement request message identifies a reporting interval identifying an amount of time (e.g., a number of seconds, milli-seconds, etc.) that the UE 130 is to store beam measurements. For example, the measurement request message may cause the UE 130 to store beam measurements captured during each reporting interval. The LMF 120 may request the beam measurements no later than an amount of time as defined by the reporting interval after having received positioning data from the UE 130.

In some examples, LMF 120 transmits an untrained machine learning model to a UE 130, such as UE 130a. For instance, LMF 120 may include parameters characterizing the machine learning model within a model training request message, and may transmit the model training request message to UE 130a. The model training request message may cause UE 130a to establish the machine learning model, and to train the machine learning model based on one or more beam measurements. For instance, UE 130a may generate features based on beam measurements for one or more beams of BS 110, and may input the features to the established machine learning model during training. The machine learning model may be trained to generate output data characterizing the UE's 130a position. In some examples, UE 130a continues to train the machine learning model until at least one metric is satisfied.

In some instances, UE 130a establishes the trained machine learning model, and applies the trained machine learning model to beam measurements to determine its own position. In some instances, UE 130a transmits the trained machine learning model to nearby UEs 130, such as UE 130g, that are within a same geographical area, such as geographical area 133. Geographical area 133 may correspond to a same zone (e.g., a same zone ID), or within a predefined radius from UE 130a. The UEs 130 receiving the trained machine learning model may establish the trained machine learning model, and may, during inference, apply the trained machine learning model to features generated from beam measurements to determine their position. The UEs 130 may then transmit position data characterizing their position to LMF 120.

Further, and based on measurement information received from UEs 130 as well as information received from BS 110, LMFs 120 can generate and transmit (e.g., broadcast) assistance data to UEs 130. The assistance data may include, for example, reference times, reference locations, ionospheric models, earth orientation parameters, time offsets, differential corrections, Ephemeris and Clock Models, health status, data bit assistance, acquisition assistance, almanac, and UTC models, among others.

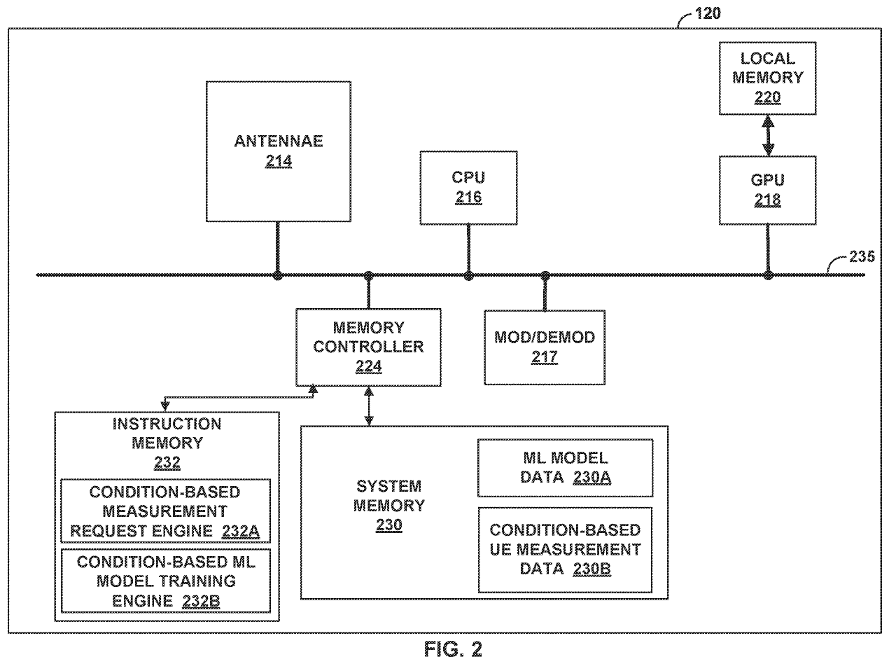

FIG. 2 illustrates a block diagram of an exemplary LMF 120. The functions of LMF 120 may be implemented in one or more processors, one or more field-programmable gate arrays (FPGAs), one or more application-specific integrated circuits (ASICs), one or more state machines, digital circuitry, any other suitable circuitry, or any suitable hardware. LMF 120 may perform one or more of the exemplary functions and processes described in this disclosure. For example, the functions of LMF 120 may be implemented across one or more servers, such as one or more cloud-based servers, or any other suitable computing devices.

As illustrated in the example of FIG. 2, LMF 120 may include an antenna 214 which may be an antenna array, a central processing unit (CPU) 216, a modulator/demodulator 217, a graphics processing unit (GPU) 218, a local memory 220 of GPU 218, and a memory controller 224 that provides access to system memory 230 and to instruction memory 232.

Memory controller 224 may be communicatively coupled to system memory 230 and to instruction memory 232. Memory controller 224 may facilitate the transfer of data going into and out of system memory 230 and/or instruction memory 232. For example, memory controller 224 may receive memory read and write commands, such as from CPU 216 or GPU 218, and service such commands to provide memory services to system memory 230 and/or instruction memory 232. Although memory controller 224 is illustrated as being separate from both CPU 216 and system memory 230, in other examples, some or all of the functionality of memory controller 224 with respect to servicing system memory 230 may be implemented on one or both of CPU 216 and system memory 230. Likewise, some or all of the functionality of memory controller 224 with respect to servicing instruction memory 232 may be implemented on one or both of CPU 216 and instruction memory 232.

System memory 230 may store program modules and/or instructions and/or data that are accessible and executed by CPU 216 and/or GPU 218. For example, system memory 130 may store applications that, when executed, provide location support services to UEs 130 as described herein. In this example, system memory 130 stores machine learning (ML) model data 230a and condition-based UE measurement data 230b. ML model data 230a may include data characterizing a machine learning model. For instance, ML model data 230a may include one or more parameters that characterize the machine learning model. LMF 120 can establish (e.g., execute) the machine learning model based on ML model data 230a. As described herein, in some instances LMF 120 may receive parameters characterizing a trained a machine learning model from a UE 130, and may store the received parameters as ML model data 230a within system memory 130.

Condition-based UE measurement data 230b may characterize measurements received from UEs 130, such as beam measurements and position measurements. For example, condition-based UE measurement data 230b may include statistical values received from UEs 130. Further, condition-based UE measurement data 230b may include measurement values transmitted by one or more UEs 130 as a result of one or more triggering conditions being satisfied, as described herein.

System memory 130 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media, cloud-based storage medium, or an optical storage media.

CPU 216 may store data to, and read data from, system memory 230 via memory controller 224. For example, CPU 216 may store a working set of instructions to system memory 230, such as instructions loaded from instruction memory 232. CPU 216 may also use system memory 230 to store dynamic data created during the operation of LMF 120. For example, CPU 216 may store measurement data, such as beam measurement data and position data (e.g., received from UEs 130), within system memory 230. CPU 116 may comprise a general-purpose or a special-purpose processor that controls operation of LMF 120.

GPU 218 may store data to, and read data from, local memory 220. For example, GPU 218 may store a working set of instructions to local memory 220, such as instructions loaded from instruction memory 232. GPU 218 may also use local memory 220 to store dynamic data created during the operation of LMF 120. Examples of local memory 220 include one or more volatile or non-volatile memories or storage devices, such as RAM, SRAM, DRAM, EPROM, EEPROM, flash memory, a magnetic data media, a cloud-based storage medium, or an optical storage media.

Instruction memory 232 may store instructions that may be accessed (e.g., read) and executed by one or more of CPU 216 and GPU 218. For example, instruction memory 232 may store instructions that, when executed by one or more of CPU 216 and GPU 218, cause one or more of CPU 216 and GPU 218 to perform one or more of the operations described herein. For instance, instruction memory 132 can include condition-based measurement request engine 232A and condition-based ML model training engine 232B. Condition-based measurement request engine 232A may include instructions that, when executed by one or more of CPU 216 and GPU 218, cause CPU 216 and GPU 218 to generate measurement request messages as described herein. Further, and when executed by one or more of CPU 216 and GPU 218, the instructions can cause one or more of CPU 216 and GPU 218 to provide the measurement request messages to modulator/demodulator 217 for transmission. Condition-based measurement request engine 232A may include further instructions that, when executed by one or more of CPU 216 and GPU 218, cause executed by one or more of CPU 216 and GPU 218 to receive and process a measurement response message as described herein. For example, the measurement response messages may be generated by a UE, such as a UE 130, and may include, for instance, beam measurement data, UE position data, or any other data described herein.

Condition-based ML model training engine 232B may include instructions that, when executed by one or more of CPU 216 and GPU 218, cause CPU 216 and GPU 218 to train a machine learning model, such as one characterized by ML model data 230a, as described herein. For instance, the executed condition-based ML model training engine 232B may generate features based on statistical values received from UEs, such as UEs 130, and may input the features to the executed machine learning model during training. Further, based on the inputted features, the executed machine learning model may generate output data characterizing, for example, a position (e.g., a UE's position). The training may include, for instance, supervised or unsupervised learning. Further, the executed condition-based ML model training engine 232B may determine whether one or more metrics are satisfied based on the output data, and may store parameters characterizing the trained machine learning model within system memory 230.

Condition-based ML model training engine 232B may also include instruction that, when executed by one or more of CPU 216 and GPU 218, cause CPU 216 and GPU 218 to generate a model training request message as described herein. Further, and when executed by one or more of CPU 216 and GPU 218, the instructions can cause one or more of CPU 216 and GPU 218 to provide the measurement request messages to modulator/demodulator 217 for transmission. Further, condition-based ML model training engine 232B may include instruction that, when executed by one or more of CPU 216 and GPU 218, cause CPU 216 and GPU 218 to receive and process a model training response message as described herein. For example, the model training response message may be generated by a UE, such as a UE 130, and may include, for instance, parameters characterizing a trained machine learning model.

The various components of LMF 120, as illustrated in FIG. 2, may be configured to communicate with each other across bus 235. Bus 235 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus), or another type of bus or device interconnect. It is to be appreciated that the specific configuration of components and communication interfaces between the different components shown in FIG. 2 is merely exemplary, and other configurations of the components, and/or other processing systems with the same or different components, may be configured to implement the operations and processes of this disclosure.

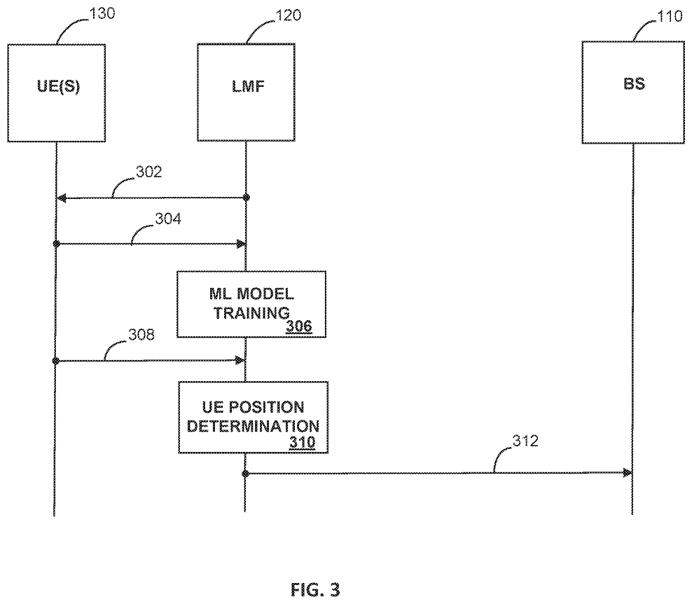

FIG. 3 illustrates messaging amount a UE 130, and LMF 120, and a BS 110. As illustrated, LMF 120 generates a measurement request message 302 requesting that UE 130 report values that are determined based on at least one reporting condition of beam measurements. For example, measurement request message 302 may include a condition field identifying one or more reporting conditions. LMF 120 transmits the measurement request message 302 to UE 130, causing UE 130 to determine the one or more reporting values based on the one or more reporting conditions identified within the condition field of the measurement request message 302. In response, UE 130 generates one or more measurement response messages 304 that include the one or more values determined on the requested reporting conditions of beam measurements.

As described herein, one example of a reporting condition requires for a statistical measurement of beam measurements. For instance, the measurement request message 302 may include a measurement interval (e.g., a measurement interval) field that identifies a measurement interval. For instance, the measurement interval may be a number (e.g., 3) of PRS measurement occasions. UE 130 may capture beam measurements during each of a multitude of measurement intervals (e.g., continuous measurement intervals), and may determine a statistical measurement (e.g., average values) for beam measurements corresponding to each measurement interval. UE 130 may generate and transmit a measurement response message 304 that includes the statistical values at the conclusion of each measurement interval.

Based on receiving one or more measurement response messages 304 that include the statistical values, LMF 120 may perform operations 306 to train a machine learning model, such as one characterized by ML model data 230a. The machine learning model may be trained to generate output data characterizing a UE's 130 position based on statistical values generated from beam measurements. For instance, LMF 120 may extract statistical values from each received measurement response message 304, and generate features based on the extracted statistical values. Further, LMF 120 may train the executed machine learning model by inputting the generated features. The executed machine learning model may generate output data characterizing, for example, UE positions.

Once trained, LMF 120 may apply the executed and trained machine learning model to received statistical values to determine a UE's 130 position. For example, a UE 130 may transmit a measurement response message 308 that includes statistical values generated from beam measurements (e.g., beam measurements for a beam of BS 110). LMF 120 may extract the statistical values from the measurement response message 308, and may perform operations 310 to apply the executed and trained machine learning model to the extracted statistical values to generate output data characterizing the UE's 130 position. In some instances, LMF 120 generates a UE position message 312 that identifies the determined position of the UE, and transmits the UE position message 312 to BS 110.

As described herein, in some examples, a reporting condition may include a triggering condition. The triggering condition may include one or more thresholds (e.g., a positioning measurement threshold) that UE 130 uses to compare with measurements to determine whether to transmit positioning measurements. The triggering condition can include, for example, a condition that a positioning accuracy value exceed a positioning accuracy threshold, or a condition that a signal-to-noise ratio exceed a signal-to-noise threshold. In some examples, the triggering condition can include a first condition that a first type of positioning accuracy value (e.g., positioning measurement accuracy value) exceed a first positioning accuracy threshold, and a second condition that a second type of positioning accuracy value (signal-to-noise ratio) exceed a second positioning accuracy threshold. In some examples, each of the conditions must be satisfied for UE 130 to transmit position measurements. In some examples, any one of the conditions may be satisfied for the UE 130 to transmit position measurements. The number of conditions can be any suitable number, such as one or more.

In this example, LMF 120 may generate and transmit to UE 130 a measurement request message 302 that identifies the conditions. In response to receiving measurement request message 302, UE 130 may determine, for a session, whether one or more of the conditions have been satisfied. For instance, UE 130 may determine whether a determined signal-to-noise ratio on a beam of BS 110 exceeds a received signal-to-noise ratio, or whether a determined position accuracy value exceeds a received position accuracy value threshold, depending on the condition received in the measurement request message 302. If the condition is satisfied, UE 130 generates a measurement response message 304 that includes position measurements determined for the corresponding session, and transmits the measurement response message 304 to LMF 120. In some instances, LMF 120 generates a UE position message 312 that identifies the received position of the UE, and transmits the UE position message 312 to BS 110.

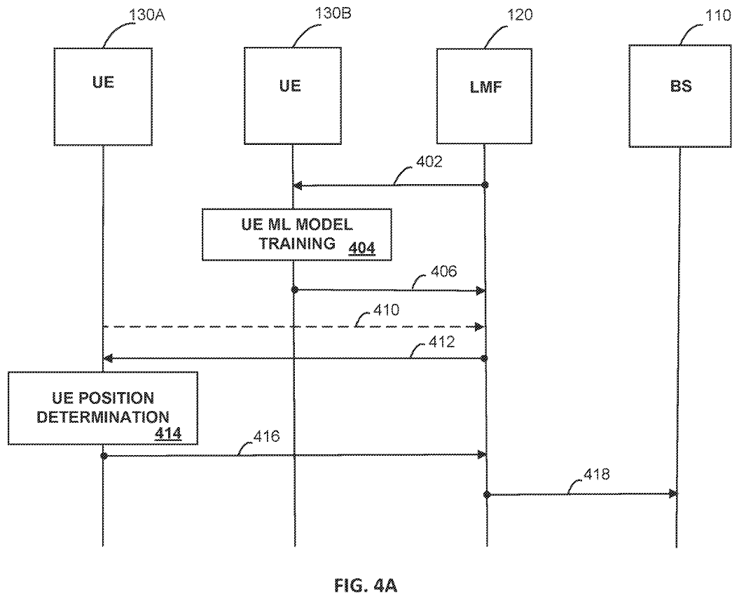

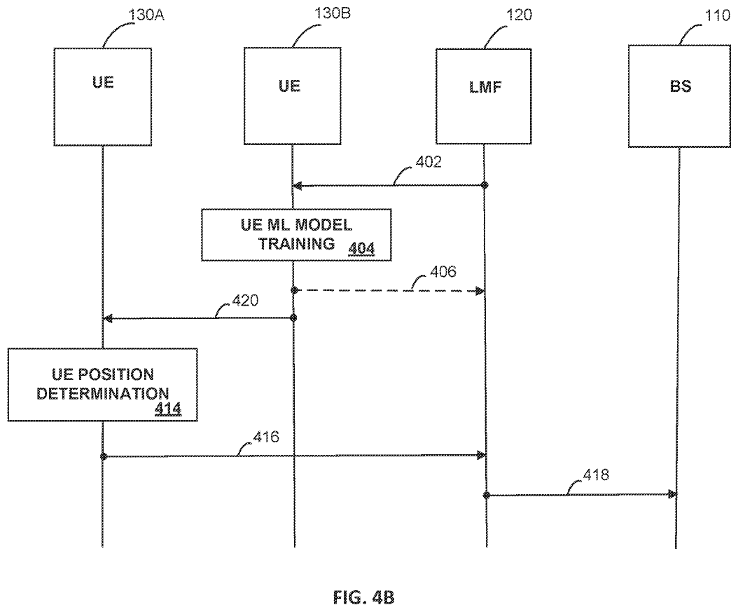

FIGS. 4A and 4B illustrate messaging among UEs 130a, 130b, LMF 120, and BS 110. With reference to FIG. 4A, LMF 120 generates a model training request message 402 that that characterizes an untrained machine learning model. For example, LMF 120 may obtain from a data repository, such as system memory 130, parameters that define an untrained machine learning model (e.g., parameters included within ML model data 230a). LMF 120 may transmit the model training request message 402 to UE 130b. In response to receiving model training request message 402, UE 130b may extract the parameters characterizing the untrained machine learning model from model training request message 402, and may establish the untrained machine learning model based on the extracted parameters.

Further, UE 130b may perform operations 404 to train the established machine learning model based on beam measurements, such as beam measurements of a beam of BS 110. For example, and when operating in a UE-based positioning mode, UE 130b may determine one or more beam measurements based on a beam received from BS 110. Additionally, UE 130b may generate features based on the beam measurements, and may input the generated features to the established machine learning model. The established machine learning model may generate output data characterizing, for instance, a UE's position. Based on the output data, UE 130b may determine whether to continue training the established machine learning model. For instance, UE 130b may determine, based on the output data, one or more metrics, and may compare the one or more metrics to corresponding thresholds to determine whether the established machine learning model is sufficiently trained. If, for example, the one or more metrics meet or exceed their corresponding threshold, UE 130b determines that training is complete. Otherwise, if the one or more metrics do not meet their corresponding threshold, UE 130b continues to train the established machine learning model.

Once trained, UE 130b may generate a model training response message 406 that characterizes the trained machine learning model. For instance, UE 130b may extract parameters (e.g., hyperparameters, weights, coefficients, etc.) from the established and trained machine learning model, and may populate the model training response message 406 with the extracted parameters. Further, UE 130b may transmit the model training response message 406 to LMF 120.

In some instances, UE 130b may apply the trained machine learning model during inference, such as to determine the UE's 130b position based on beam measurements. For example, UE 130b may generate features based on beam measurements for a received beam, and may input the features to the established and trained machine learning model to generate position data characterizing the UE's 130b position. UE 130b may then transmit the position data to LMF 120.

In some examples, LMF 120 generates a trained model message 412 that characterizes the trained machine learning model, and transmits the trained model message to another UE, such as UE 130a. In some instances, LMF 120 may transmit the trained model message 412 to UE 130a in response to receiving a trained model request message 410. Further, UE 130a may establish the trained machine learning model based on receiving trained model message 412, and may perform operations 414 to determine its position based on applying the trained machine learning model to beam measurements from one or more beams, such as a beam from BS 110. For example, UE 130a may generate features based on beam measurements for a received beam, and may input the features to the established and trained machine learning model to generate position data 416 characterizing the UE's 130a position. UE 130a may then transmit the position data 416 to LMF 120. In some instances, LMF 120 packages the position data 416 received from UE 130a within a UE position reporting message 418, and transmits the UE position reporting message 418 to BS 110.

With reference to FIG. 4B, in some instances, instead of, or in addition to, transmitting a model training response message 406 to LMF 120, UE 130b may generate and transmit to other UEs, such as UE 130a, a trained model message 420 that characterizes the trained machine learning model. For example, UE 130b may detect nearby UE's, such as UE's within the same geographical location of UE 130b, and may transmit the trained model message 420 characterizing the trained machine learning model to the nearby UEs. In some examples, the geographical location may be a zone (e.g., zone ID) or radius that UE 130b may share the trained machine learning model with other UEs (e.g., slave UEs). The zone or radius may be determined by, for example, LMF 120, and may be transmitted by LMF 120 to UE 130b. For instance, UE 130b may establish communications with any other UE within the zone or radius, and may transmit the trained model message 420 to the UEs within the zone or radius, such as UE 130a.

Further, UE 130a may establish the trained machine learning model based on receiving the trained model message 420, and may determine its position based on applying the established trained machine learning model to beam measurements. For example, UE 130a may generate features based on beam measurements for a received beam, and may input the features to the established and trained machine learning model to generate position data 416 characterizing the UE's 130a position. UE 130a may then transmit the position data 416 to LMF 120. In some instances, LMF 120 packages the position data 416 received from UE 130a within a UE position reporting message 418, and transmits the UE position reporting message 418 to BS 110.

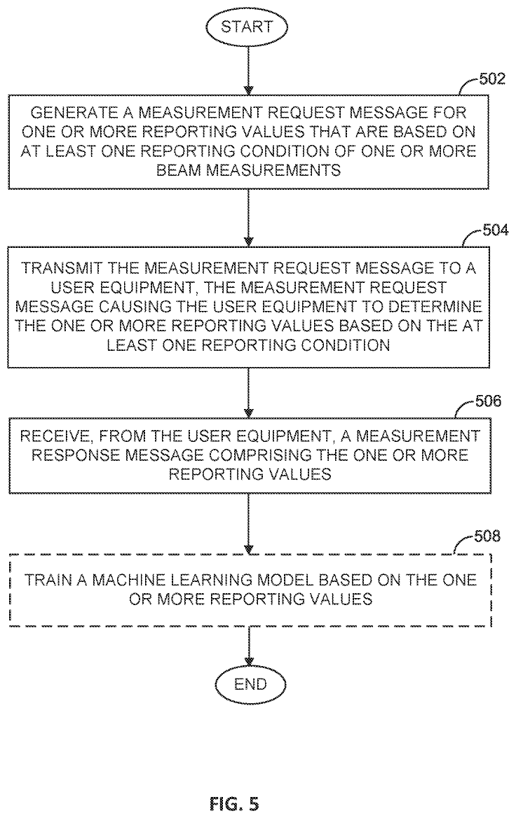

FIG. 5 is a flowchart of an example process 500 for communicating measurement data. Process 500 may be performed by one or more processors executing instructions locally at a computing device, such as by one or more of CPU 116 and GPU 118 of LMF 120 of FIGS. 1 and 2. Accordingly, the various operations of process 500 may be represented by executable instructions held in storage media of one or more computing platforms, such as instruction memory 232 of LMF 120.

Beginning at block 502, LMF 120 generates a measurement request message for one or more reporting values that are based on at least one reporting condition of one or more beam measurements. For instance, LMF 120 may generate a measurement request message 302 that characterizes a reporting condition of beam measurements. As described herein, in some examples, such as when operating in a UE-assisted positioning mode, the reporting condition may include a request for statistical data based on beam measurements, such as PRS measurements, where the statistical data is based on beam measurements captured over corresponding measurement intervals. For instance, the statistical data may include an average signal strength value determined over a measurement interval. In other examples, such as when operating in a UE-based positioning mode, the reporting condition can include a request to transmit position measurements when at least one triggering condition is satisfied. The triggering condition can include, for example, a condition that a positioning accuracy value satisfies a positioning accuracy threshold, or that a measured signal-to-noise ratio satisfies a signal-to-noise threshold.

At block 504, LMF 120 transmits the measurement request message to a UE causing the UE to determine the one or more reporting values based on the at least one reporting condition. For example, in response to receiving the measurement request message with a request for statistical data based on beam measurements (e.g., when operating in UE-assisted positioning mode), the UE may measure DL-PRS resources during a measurement interval, and may determine a statistical value for a measurement interval based on the measurements captured during the measurement interval. The one or more reporting values may comprise the determined statistical values. As another example, in response to receiving the measurement request message with a request to transmit position measurements when at least one triggering condition is satisfied (e.g., when operating in UE-based positioning mode), the UE may determine its position when the at least one triggering condition is satisfied (e.g., when the positioning accuracy value exceeds the positioning accuracy threshold, when the measured signal-to-noise ratio exceeds the signal-to-noise threshold, etc.). The one or more reporting values may include the determined position (e.g., position data).

Further, and at block 506, LMF 120 receives from the UE a measurement response message that includes the one or more reporting values. In some instances, such as when the reporting values include statistical data, at block 508 LMF 120 trains a machine learning model based on the one or more reporting values. For example, LMF 120 may extract the reporting values (e.g., statistical values) from the measurement response message, and may perform operations 306 to train a machine learning model, such as one characterized by ML model data 230a. The machine learning model may be trained to generate output data characterizing a UE's position. For instance, LMF 120 may extract statistical values from each received measurement response message 304, and may generate features based on the extracted statistical values. Further, LMF 120 may train the executed machine learning model by inputting the generated features to the executed machine learning model, and the executed machine learning model may generate output data characterizing UE positions. In some examples, LMF 120 stores parameters characterizing the trained machine learning model in a data repository, such as within system memory 130.

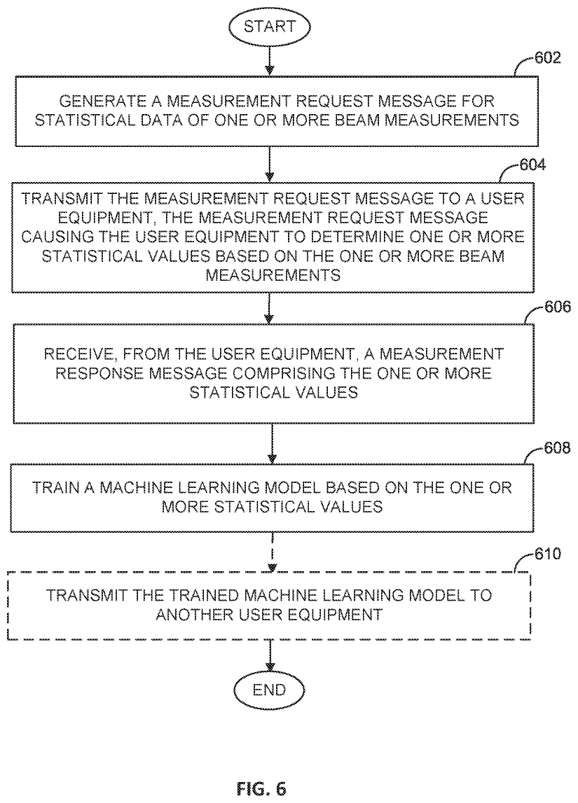

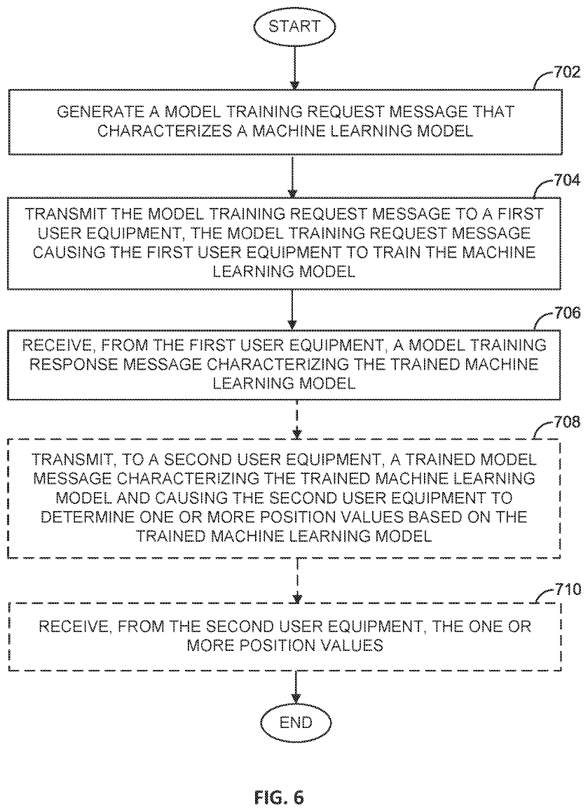

FIG. 6 is a flowchart of an example process 600 for training a machine learning model. Process 600 may be performed by one or more processors executing instructions locally at a computing device, such as by one or more of CPU 116 and GPU 118 of LMF 120 of FIGS. 1 and 2. Accordingly, the various operations of process 600 may be represented by executable instructions held in storage media of one or more computing platforms, such as instruction memory 232 of LMF 120.

Beginning at block 602, LMF 120 generates a measurement request message for statistical data of one or more beam measurements. Further, at block 604, LMF 120 transmits the measurement request message to a UE, where the measurement request message causes the UE to determine one or more statistical values based on the one or more beam measurements. As an example, LMF 120 may generate a measurement request message 302 for statistical data that are determined based on beam measurements, such as PRS measurements. The measurement request message 302 may include a measurement interval, where the statistical data is to be determined based on beam measurements for the measurement interval. For instance, the statistical data may include an average signal strength value determined over the measurement interval. LMF may transmit the measurement request message 302 to a UE 130. Further, UE 130 may receive the measurement request message 302, and may determine the statistical values based on beam measurements of a beam of BS 110 for each of one or more measurement intervals.

Proceeding to block 606, LMF 120 receives, from the UE, a measurement response message comprising the one or more statistical values. For example, UE 130 may generate, for each measurement interval, a measurement response message 304 that includes one or more statistical values corresponding to each measurement interval. UE 130 may transmit the measurement response message 304 to LMF 120.

At block 608 LMF 120 trains a machine learning model based on the one or more statistical values. For example, LMF 120 may extract the statistical values from the measurement response message, and may perform operations 306 to train a machine learning model, such as one characterized by ML model data 230a. The machine learning model may be trained to generate output data characterizing a UE's position. For instance, LMF 120 may extract statistical values from each received measurement response message 304, and may generate features based on the extracted statistical values. Further, LMF 120 may train the executed machine learning model by inputting the generated features to the executed machine learning model, and the executed machine learning model may generate output data characterizing UE positions. In some examples, LMF 120 stores parameters characterizing the trained machine learning model in a data repository, such as within system memory 130.

In some instances, at block 610, LMF 120 transmits the trained machine learning model to another UE. For example, LMF 120 may determine that one or more additional UEs are located within a same geographical area as the UE that reported the statistical values. LMF 120 obtain parameters characterizing the trained machine learning model from system memory 130, and may populate a trained model message 412 with the parameters. Further, LMF 120 may transmit the trained model message 412 to the additional UEs. The additional UEs may establish the trained machine learning model based on the received parameters, and may establish the trained machine learning model to determine their positions.

FIG. 7 is flowchart of an example process 700 for training a machine learning model. Process 700 may be performed by one or more processors executing instructions locally at a computing device, such as by one or more of CPU 116 and GPU 118 of LMF 120 of FIGS. 1 and 2. Accordingly, the various operations of process 700 may be represented by executable instructions held in storage media of one or more computing platforms, such as instruction memory 232 of LMF 120.

Beginning at block 702, LMF 120 generates a model training request message that characterizes a machine learning model (e.g., an untrained machine learning model). For example, LMF 120 may obtain ML model data 230a from system memory 230, where the ML model data 230a includes parameters for an untrained machine learning model. LMF 120 may populate a model training request message 402 with the parameters.

At block 704, LMF 120 transmits the model training request message to a first UE. The model training request message causes the first UE to train the machine learning model. For example, LMF 120 may transmit a model training request message 402 to UE 130b, causing UE 130b to extract the parameters characterizing the machine learning model, and establish (e.g., configure and execute) the machine learning model based on the extracted parameters. Further, the UE 130b may perform operations 404 to train the established machine learning model based on beam measurements, such as beam measurements of a beam of BS 110. For example, and when operating in a UE-based positioning mode, UE 130b may determine one or more beam measurements based on a beam received from BS 110. Additionally, UE 130b may generate features based on the beam measurements, and may input the generated features to the established machine learning model. The established machine learning model may generate output data characterizing, for instance, a UE's position.

Based on the output data, UE 130b may determine whether to continue training the established machine learning model. For instance, UE 130b may determine, based on the output data, one or more metrics, and may compare the one or more metrics to corresponding thresholds to determine whether the established machine learning model is sufficiently trained. If, for example, the one or more metrics meet or exceed their corresponding threshold, UE 130b determines that training is complete. Otherwise, if the one or more metrics do not meet their corresponding threshold, UE 130b continues to train the established machine learning model.

Proceeding to block 706, LMF 120 may receive, from the first UE, a model training response message characterizing the trained machine learning model. For instance, once the machine learning model is trained, UE 130b may populate a model training response message 406 with parameters characterizing the trained machine learning model, and may transmit the model training response message 406 to LMF 120. LMF 120 may extract the parameters from the model training response message 406, and may store the parameters characterizing the trained machine learning model within system memory 230 (e.g., within ML model data 230a).

In some instances, at block 708, LMF 120 may transmit to a second UE a trained model message characterizing the trained machine learning model, which causes the second UE to determine one or more position values based on the trained machine learning model. For example, LMF 120 may generate a trained model message 412 that includes parameters for the trained machine learning model, such as the parameters stored within system memory 230 (e.g., within ML model data 230a). Further, LMF may transmit the trained model message 412 to UE 130a, causing UE 130a to establish the trained machine learning model based on the received parameters, and to perform operations 414 to determine its position based on applying the trained machine learning model to beam measurements from one or more beams, such as a beam from BS 110. For example, UE 130a may generate features based on beam measurements for a received beam, and may input the features to the established and trained machine learning model to generate position data 416 characterizing the UE's 130a position. Further, in some instances, at block 710 LMF receives, from the second UE, the one or more position values. For example, UE 130a may transmit the position data 416 to LMF 120.

Implementation examples are further described in the following numbered clauses:
1. An apparatus comprising:
   a non-transitory, machine-readable storage medium storing instructions; and
   at least one processor coupled to the non-transitory, machine-readable storage medium, the at least one processor being configured to:
      generate a measurement request message for one or more reporting values that are determined based on at least one reporting condition of one or more beam measurements;
      transmit the measurement request message to a user equipment, the measurement request message causing the user equipment to determine the one or more reporting values based on the at least one reporting condition of the one or more beam measurements;
      receive, from the user equipment, a measurement response message comprising the one or more reporting values; and
      train a machine learning model based on the one or more reporting values.
2. The apparatus of clause 1, wherein the at least one reporting condition comprises a statistical measurement of the one or more beam measurements, and the one or more reporting values comprise one or more statistical values characterizing the statistical measurement.
3. The apparatus of any of clauses 1-2, wherein the at least one processor is configured to execute the instructions to generate the measurement request message to comprise a measurement interval, wherein the measurement request message causes the user equipment to capture the one or more beam measurements during corresponding periods based on the measurement interval, and to determine the one or more reporting values based on the one or more beam measurements captured during the corresponding periods.
4. The apparatus of any of clauses 1-3, wherein the at least one processor is configured to execute the instructions to generate the measurement request message to comprise a reporting interval, wherein the measurement request message causes the user equipment to transmit the one or more reporting values based on the reporting interval.
5. The apparatus of any of clauses 1-4, wherein the at least one reporting condition comprises a triggering condition, and wherein the measurement request message causes the user equipment to determine the one or more reporting values when the triggering condition is satisfied.
6. The apparatus of any of clauses 1-5, wherein the at least one processor is configured to execute the instructions to transmit trained model data characterizing the trained machine learning model to at least one of a plurality of user equipments.
7. The apparatus of clause 6, wherein the at least one processor is further configured to execute the instructions to:
determine the user equipment is in a geographical area;
determine the at least one of the plurality of user equipments is in the geographical area; and
transmit the trained model data to the at least one of the plurality of user equipments in response to determining the at least one of the plurality of user equipments is in the geographical area.
8. The apparatus of any of clauses 6-7, wherein the at least one processor is configured to execute the instructions to receive, from the at least one of the plurality of user equipments, positioning data determined based on the trained machine learning model.
9. The apparatus of any of clauses 1-8, wherein the at least one processor is configured to execute the instructions to:
receive, from at least one of a plurality of user equipments, additional reporting values; and
determine a position of the at least one of the plurality of user equipments based on applying the trained machine learning model to the additional reporting values.
10. A method comprising:
generating a measurement request message for one or more reporting values that are determined based on at least one reporting condition of one or more beam measurements;
transmitting the measurement request message to a user equipment, the measurement request message causing the user equipment to determine the one or more reporting values based on the at least one reporting condition of the one or more beam measurements;
receiving, from the user equipment, a measurement response message comprising the one or more reporting values; and
training a machine learning model based on the one or more reporting values.
11. The method of clause 10, wherein the at least one reporting condition comprises a statistical measurement of the one or more beam measurements, and the one or more reporting values comprise one or more statistical values characterizing the statistical measurement.
12. The method of any of clauses 10-11 comprising generating the measurement request message to comprise a measurement interval, wherein the measurement request message causes the user equipment to capture the one or more beam measurements during corresponding periods based on the measurement interval, and to determine the one or more reporting values based on the one or more beam measurements captured during the corresponding periods.
13. The method of any of clauses 10-12 comprising generating the measurement request message to comprise a reporting interval, wherein the measurement request message causes the user equipment to transmit the one or more reporting values based on the reporting interval.
14. The method of any of clauses 10-13, wherein the at least one reporting condition comprises a triggering condition, and wherein the measurement request message causes the user equipment to determine the one or more reporting values when the triggering condition is satisfied.
15. The method of any of clauses 10-14 comprising transmitting trained model data characterizing the trained machine learning model to at least one of a plurality of user equipments.
16. The method of clause 15 comprising:
determining the user equipment is in a geographical area;
determining the at least one of the plurality of user equipments is in the geographical area; and
transmitting the trained model data to the at least one of the plurality of user equipments in response to determining the at least one of the plurality of user equipments is in the geographical area.
17. The method of any of clauses 15-16 comprising receiving, from the at least one of the plurality of user equipments, positioning data determined based on the trained machine learning model.
18. The method of any of clauses 10-17 comprising:
receiving, from at least one of a plurality of user equipments, additional reporting values; and
determining a position of the at least one of the plurality of user equipments based on applying the trained machine learning model to the additional reporting values.
19. A non-transitory, machine-readable storage medium storing instructions that, when executed by at least one processor, causes the at least one processor to perform operations that include:
generating a measurement request message for one or more reporting values that are determined based on at least one reporting condition of one or more beam measurements;
transmitting the measurement request message to a user equipment, the measurement request message causing the user equipment to determine the one or more reporting values based on the at least one reporting condition of the one or more beam measurements;
receiving, from the user equipment, a measurement response message comprising the one or more reporting values; and
training a machine learning model based on the one or more reporting values.
20. The non-transitory, machine-readable storage medium of clause 19, wherein the at least one reporting condition comprises a statistical measurement of the one or more beam measurements, and the one or more reporting values comprise one or more statistical values characterizing the statistical measurement.
21. The non-transitory, machine-readable storage medium of any of clauses 19-20, wherein the instructions, when executed by the at least one processor, cause the at least one processor to perform operations that include generating the measurement request message to comprise a measurement interval, wherein the measurement request message causes the user equipment to capture the one or more beam measurements during corresponding periods based on the measurement interval, and to determine the one or more reporting values based on the one or more beam measurements captured during the corresponding periods.
22. The non-transitory, machine-readable storage medium of any of clauses 19-21, wherein the instructions, when executed by the at least one processor, cause the at least one processor to perform operations that include generating the measurement request message to comprise a reporting interval, wherein the measurement request message causes the user equipment to transmit the one or more reporting values based on the reporting interval.
23. The non-transitory, machine-readable storage medium of any of clauses 19-22, wherein the at least one reporting condition comprises a triggering condition, and wherein the measurement request message causes the user equipment to determine the one or more reporting values when the triggering condition is satisfied.
24. The non-transitory, machine-readable storage medium of any of clauses 19-23, wherein the instructions, when executed by the at least one processor, cause the at least one processor to perform operations that include transmitting trained model data characterizing the trained machine learning model to at least one of a plurality of user equipments.
25. The non-transitory, machine-readable storage medium of clause 24, wherein the instructions, when executed by the at least one processor, cause the at least one processor to perform operations that include:
determining the user equipment is in a geographical area;
determining the at least one of the plurality of user equipments is in the geographical area; and
transmitting the trained model data to the at least one of the plurality of user equipments in response to determining the at least one of the plurality of user equipments is in the geographical area.
26. The non-transitory, machine-readable storage medium of any of clauses 24-25, wherein the instructions, when executed by the at least one processor, cause the at least one processor to perform operations that include receiving, from the at least one of the plurality of user equipments, positioning data determined based on the trained machine learning model.
27. The non-transitory, machine-readable storage medium of any of clauses 19-26, wherein the instructions, when executed by the at least one processor, cause the at least one processor to perform operations that include:
receiving, from at least one of a plurality of user equipments, additional reporting values; and
determining a position of the at least one of the plurality of user equipments based on applying the trained machine learning model to the additional reporting values.
28. A computing device comprising:
a means for generating a measurement request message for one or more reporting values that are determined based on at least one reporting condition of one or more beam measurements;
a means for transmitting the measurement request message to a user equipment, the measurement request message causing the user equipment to determine the one or more reporting values based on the at least one reporting condition of the one or more beam measurements;
a means for receiving, from the user equipment, a measurement response message comprising the one or more reporting values; and
a means for training a machine learning model based on the one or more reporting values.
29. The computing device of clause 28 wherein the at least one reporting condition comprises a statistical measurement of the one or more beam measurements, and the one or more reporting values comprise one or more statistical values characterizing the statistical measurement.
30. The computing device of any of clauses 28-29 comprising a means for generating the measurement request message to comprise a measurement interval, wherein the measurement request message causes the user equipment to capture the one or more beam measurements during corresponding periods based on the measurement interval, and to determine the one or more reporting values based on the one or more beam measurements captured during the corresponding periods.
31. The computing device of any of clauses 28-30 comprising a means for generating the measurement request message to comprise a reporting interval, wherein the measurement request message causes the user equipment to transmit the one or more reporting values based on the reporting interval.
32. The computing device of any of clauses 28-32, wherein the at least one reporting condition comprises a triggering condition, and wherein the measurement request message causes the user equipment to determine the one or more reporting values when the triggering condition is satisfied.
33. The computing device of any of clauses 28-32 comprising a means for transmitting trained model data characterizing the trained machine learning model to at least one of a plurality of user equipments.
34. The computing device of clause 33 comprising:
a means for determining the user equipment is in a geographical area;
a means for determining the at least one of the plurality of user equipments is in the geographical area; and
a means for transmitting the trained model data to the at least one of the plurality of user equipments in response to determining the at least one of the plurality of user equipments is in the geographical area.
35. The computing device of any of clauses 33-34 comprising a means for receiving, from the at least one of the plurality of user equipments, positioning data determined based on the trained machine learning model.
36. The computing device of any of clauses 35 comprising:
a means for receiving, from at least one of a plurality of user equipments, additional reporting values; and
a means for determining a position of the at least one of the plurality of user equipments based on applying the trained machine learning model to the additional reporting values.
37. An apparatus comprising:
a non-transitory, machine-readable storage medium storing instructions; and
at least one processor coupled to the non-transitory, machine-readable storage medium, the at least one processor being configured to execute the instructions to:
   generate a measurement request message for one or more position values that are determined based on at least one triggering condition, and wherein the measurement request message causes the user equipment to determine the one or more position values when the triggering condition is satisfied;
   transmit the measurement request message to a user equipment, the measurement request message causing the user equipment to determine the one or more position values based on the at least one triggering condition; and
   receive, from the user equipment, a measurement response message comprising the one or more position values.
38. The apparatus of clause 37, wherein the triggering condition comprises at least one of: a first condition that a positioning accuracy value satisfies a positioning accuracy threshold, and a second condition that a beam signal-to-noise value satisfies a beam signal-to-noise threshold.
39. A method comprising:
generating a measurement request message for one or more position values that are determined based on at least one triggering condition, and wherein the measurement request message causes the user equipment to determine the one or more position values when the triggering condition is satisfied;
transmitting the measurement request message to a user equipment, the measurement request message causing the user equipment to determine the one or more position values based on the at least one triggering condition; and
receiving, from the user equipment, a measurement response message comprising the one or more position values.
40. The method of clause 39, wherein the triggering condition comprises at least one of: a first condition that a positioning accuracy value satisfies a positioning accuracy threshold, and a second condition that a beam signal-to-noise value satisfies a beam signal-to-noise threshold.
41. A non-transitory, machine-readable storage medium storing instructions that, when executed by at least one processor, causes the at least one processor to perform operations that include:
generating a measurement request message for one or more position values that are determined based on at least one triggering condition, and wherein the measurement request message causes the user equipment to determine the one or more position values when the triggering condition is satisfied;
transmitting the measurement request message to a user equipment, the measurement request message causing the user equipment to determine the one or more position values based on the at least one triggering condition; and
receiving, from the user equipment, a measurement response message comprising the one or more position values.
42. The non-transitory, machine-readable storage medium of clause 41, wherein the triggering condition comprises at least one of: a first condition that a positioning accuracy value satisfies a positioning accuracy threshold, and a second condition that a beam signal-to-noise value satisfies a beam signal-to-noise threshold.
43. A computing device comprising:
a means for generating a measurement request message for one or more position values that are determined based on at least one triggering condition, and wherein the measurement request message causes the user equipment to determine the one or more position values when the triggering condition is satisfied;
a means for transmitting the measurement request message to a user equipment, the measurement request message causing the user equipment to determine the one or more position values based on the at least one triggering condition; and
a means for receiving, from the user equipment, a measurement response message comprising the one or more position values.
44. The computing device of clause 43, wherein the triggering condition comprises at least one of: a first condition that a positioning accuracy value satisfies a positioning accuracy threshold, and a second condition that a beam signal-to-noise value satisfies a beam signal-to-noise threshold.
45. An apparatus comprising:
a non-transitory, machine-readable storage medium storing instructions; and
at least one processor coupled to the non-transitory, machine-readable storage medium, the at least one processor being configured to execute the instructions to:
   generate a model training request message characterizing a machine learning model;
   transmit the model training request message to a user equipment, the model training request message causing the user equipment to train the machine learning model based on one or more beam measurements;
   receive, from the user equipment, a model training response message characterizing the trained machine learning model.
46. The apparatus of clause 45, wherein the at least one processor is configured to execute the instructions to receive, from the user equipment, a position of the user equipment, wherein the user equipment is configured to determine the position based on:
applying the trained machine learning model to additional beam measurements; and
determining the position based on the additional beam measurements.
47. The apparatus of any of clauses 45-46, wherein the at least one processor is configured to execute the instructions to:
receive additional beam measurements from at least one of a plurality of user equipments;
apply the trained machine learning model to the additional beam measurements to determine a position of the at least one of the plurality of user equipments.
48. The apparatus of any of clauses 45-47, wherein the model training request message further causes the user equipment to transmit to at least one of a plurality of user equipments a trained model message characterizing the trained machine learning model.
49. The apparatus of claim 45, wherein the at least one processor is configured to execute the instructions to transmit to at least one of a plurality of user equipments a trained model message characterizing the trained machine learning model.
50. The apparatus of clause 49, wherein the at least one processor is configured to execute the instructions to receive, from the at least one of the plurality of user equipments, position data, wherein the at least one of the plurality of user equipments generated the position data based on the trained machine learning model.
51. A method comprising:
generating a model training request message characterizing a machine learning model;
transmitting the model training request message to a user equipment, the model training request message causing the user equipment to train the machine learning model based on one or more beam measurements; and
receiving, from the user equipment, a model training response message characterizing the trained machine learning model.
52. The method of clause 51 comprising receiving, from the user equipment, a position of the user equipment, wherein the user equipment is configured to determine the position based on:
applying the trained machine learning model to additional beam measurements; and
determining the position based on the additional beam measurements.
53. The method of any of clauses 51-52, comprising:
receiving additional beam measurements from at least one of a plurality of user equipments; and
applying the trained machine learning model to the additional beam measurements to determine a position of the at least one of the plurality of user equipments.
54. The method of any of clauses 51-53, wherein the model training request message further causes the user equipment to transmit to at least one of a plurality of user equipments a trained model message characterizing the trained machine learning model.
55. The method of any of clauses 51-54, comprising transmitting to at least one of a plurality of user equipments a trained model message characterizing the trained machine learning model.
56. The method of clause 55, comprising receiving, from the at least one of the plurality of user equipments, position data, wherein the at least one of the plurality of user equipments generated the position data based on the trained machine learning model.
57. A non-transitory, machine-readable storage medium storing instructions that, when executed by at least one processor, causes the at least one processor to perform operations that include:
generating a model training request message characterizing a machine learning model;
transmitting the model training request message to a user equipment, the model training request message causing the user equipment to train the machine learning model based on one or more beam measurements; and
receiving, from the user equipment, a model training response message characterizing the trained machine learning model.
58. The non-transitory, machine-readable storage medium of clause 57, wherein the instructions, when executed by the at least one processor, cause the at least one processor to perform operations that include receiving, from the user equipment, a position of the user equipment, wherein the user equipment is configured to determine the position based on:
applying the trained machine learning model to additional beam measurements; and
determining the position based on the additional beam measurements.
59. The non-transitory, machine-readable storage medium of any of clauses 57-58, wherein the instructions, when executed by the at least one processor, cause the at least one processor to perform operations that include:
receiving additional beam measurements from at least one of a plurality of user equipments; and
applying the trained machine learning model to the additional beam measurements to determine a position of the at least one of the plurality of user equipments.
60. The non-transitory, machine-readable storage medium of any of clauses 57-59, wherein the model training request message further causes the user equipment to transmit to at least one of a plurality of user equipments a trained model message characterizing the trained machine learning model.
61. The non-transitory, machine-readable storage medium of any of clauses 57-60, wherein the instructions, when executed by the at least one processor, cause the at least one processor to perform operations that include transmitting to at least one of a plurality of user equipments a trained model message characterizing the trained machine learning model.
62. The non-transitory, machine-readable storage medium of clause 61, wherein the instructions, when executed by the at least one processor, cause the at least one processor to perform operations that include receiving, from the at least one of the plurality of user equipments, position data, wherein the at least one of the plurality of user equipments generated the position data based on the trained machine learning model.
63. A computing device comprising:
a means for generating a model training request message characterizing a machine learning model;
a means for transmitting the model training request message to a user equipment, the model training request message causing the user equipment to train the machine learning model based on one or more beam measurements; and
a means for receiving, from the user equipment, a model training response message characterizing the trained machine learning model.
64. The computing device of clause 63 comprising a means for receiving, from the user equipment, a position of the user equipment, wherein the user equipment comprises a means for determining the position based on:
applying the trained machine learning model to additional beam measurements; and
determining the position based on the additional beam measurements.
65. The computing device of any of clauses 63-64 comprising:
a means for receiving additional beam measurements from at least one of a plurality of user equipments; and
a means for applying the trained machine learning model to the additional beam measurements to determine a position of the at least one of the plurality of user equipments.
66. The computing device of any of clauses 63-65, wherein the model training request message further causes the user equipment to transmit to at least one of a plurality of user equipments a trained model message characterizing the trained machine learning model.
67. The computing device of any of clauses 63-66 comprising a means for transmitting to at least one of a plurality of user equipments a trained model message characterizing the trained machine learning model.
68. The computing device of clause 67 comprising a means for receiving, from the at least one of the plurality of user equipments, position data, wherein the at least one of the plurality of user equipments generated the position data based on the trained machine learning model.

Although the methods described above are with reference to the illustrated flowcharts, many other ways of performing the acts associated with the methods may be used. For example, the order of some operations may be changed, and some embodiments may omit one or more of the operations described and/or include additional operations.

Additionally, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

1. An apparatus comprising:
a non-transitory, machine-readable storage medium storing instructions; and
at least one processor coupled to the non-transitory, machine-readable storage medium, the at least one processor being configured to:
generate a measurement request message for one or more reporting values that are determined based on at least one reporting condition of one or more beam measurements;
transmit the measurement request message to a user equipment, the measurement request message causing the user equipment to determine the one or more reporting values based on the at least one reporting condition of the one or more beam measurements;
receive, from the user equipment, a measurement response message comprising the one or more reporting values; and
train a machine learning model based on the one or more reporting values.

2. The apparatus of claim 1, wherein the at least one reporting condition comprises a statistical measurement of the one or more beam measurements, and the one or more reporting values comprise one or more statistical values characterizing the statistical measurement.

3. The apparatus of claim 1, wherein the at least one processor is configured to execute the instructions to generate the measurement request message to comprise a measurement interval, wherein the measurement request message causes the user equipment to capture the one or more beam measurements during corresponding periods based on the measurement interval, and to determine the one or more reporting values based on the one or more beam measurements captured during the corresponding periods.

4. The apparatus of claim 1, wherein the at least one processor is configured to execute the instructions to generate the measurement request message to comprise a reporting interval, wherein the measurement request message causes the user equipment to transmit the one or more reporting values based on the reporting interval.

5. The apparatus of claim 1, wherein the at least one reporting condition comprises a triggering condition, and wherein the measurement request message causes the user equipment to determine the one or more reporting values when the triggering condition is satisfied.

6. The apparatus of claim 1, wherein the at least one processor is configured to execute the instructions to transmit trained model data characterizing the trained machine learning model to at least one of a plurality of user equipments.

7. The apparatus of claim 6, wherein the at least one processor is further configured to execute the instructions to:
determine the user equipment is in a geographical area; determine the at least one of the plurality of user equipments is in the geographical area; and
transmit the trained model data to the at least one of the plurality of user equipments in response to determining the at least one of the plurality of user equipments is in the geographical area.

8. A method comprising:
generating a measurement request message for one or more reporting values that are determined based on at least one reporting condition of one or more beam measurements;
transmitting the measurement request message to a user equipment, the measurement request message causing the user equipment to determine the one or more reporting values based on the at least one reporting condition of the one or more beam measurements;
receiving, from the user equipment, a measurement response message comprising the one or more reporting values; and
training a machine learning model based on the one or more reporting values.

9. The method of claim 8, wherein the at least one reporting condition comprises a statistical measurement of the one or more beam measurements, and the one or more reporting values comprise one or more statistical values characterizing the statistical measurement.

10. The method of claim 8 comprising generating the measurement request message to comprise a measurement interval, wherein the measurement request message causes the user equipment to capture the one or more beam measurements during corresponding periods based on the measurement interval, and to determine the one or more reporting values based on the one or more beam measurements captured during the corresponding periods.

11. The method of claim 8, wherein the at least one reporting condition comprises a triggering condition, and wherein the measurement request message causes the user equipment to determine the one or more reporting values when the triggering condition is satisfied.

12. The method of claim 8, comprising transmitting trained model data characterizing the trained machine learning model to at least one of a plurality of user equipments.

13. (canceled)

14. (canceled)

15. An apparatus comprising:
a non-transitory, machine-readable storage medium storing instructions; and
at least one processor coupled to the non-transitory, machine-readable storage medium, the at least one processor being configured to execute the instructions to:
generate a model training request message characterizing a machine learning model;
transmit the model training request message to a user equipment, the model training request message causing the user equipment to train the machine learning model based on one or more beam measurements; and
receive, from the user equipment, a model training response message characterizing the trained machine learning model.

16. The apparatus of claim 15, wherein the at least one processor is configured to execute the instructions to receive, from the user equipment, a position of the user equipment, wherein the user equipment is configured to determine the position based on:
applying the trained machine learning model to additional beam measurements; and
determining the position based on the additional beam measurements.

17. The apparatus of claim 15, wherein the at least one processor is configured to execute the instructions to:
receive additional beam measurements from at least one of a plurality of user equipments; and
apply the trained machine learning model to the additional beam measurements to determine a position of the at least one of the plurality of user equipments.

18. The apparatus of claim 15, wherein the model training request message further causes the user equipment to transmit to at least one of a plurality of user equipments a trained model message characterizing the trained machine learning model.

19. The apparatus of claim 15, wherein the at least one processor is configured to execute the instructions to transmit to at least one of a plurality of user equipments a trained model message characterizing the trained machine learning model.

20. The apparatus of claim 19, wherein the at least one processor is configured to execute the instructions to receive, from the at least one of the plurality of user equipments, position data, wherein the at least one of the plurality of user equipments generated the position data based on the trained machine learning model.
